(19) United States
(12) Patent Application Publication
(10) Pub. No.: US 2009/0225775 A1
(43) Pub. Date: Sep. 10, 2009

(54) Serial Buffer To Support Reliable Connection Between Rapid I/O End-Point And FPGA Lite-Weight Protocols

(75) Inventors: Chi-Lie Wang, Milpitas, CA (US); Jason Z. Mo, Fremont, CA (US)

Correspondence Address: BEVER, HOFFMAN & HARMS, LLP, 1730 HOLMES STREET, BUILDING B, LIVERMORE, CA, 94550, US

(73) Assignee: INTEGRATED DEVICE TECHNOLOGY, INC., San Jose, CA (US)

(21) Appl. No.: 12/043,934

(22) Filed: Mar. 6, 2008

(51) Int. Cl. H04J 3/22

(52) U.S. Cl. 370/467

(57) ABSTRACT

A serial buffer includes a first port configured to implement an serial rapid I/O (sRIO) protocol and a second port configured to implement a Lite-weight serial (Lite) protocol. SRIO packets received on the first port are translated into Lite request packets compatible with the Lite protocol. The Lite request packets are transmitted to the second port. Lite response packets compatible with the Lite protocol are returned to the second port in response to the Lite request packets. The Lite response packets are translated into sRIO response packets compatible with the sRIO protocol. These sRIO response packets are returned to the first port, thereby providing a mechanism to acknowledge successful transmissions from the first port to the second port. Unsuccessful transmissions are identified by a timeout mechanism. The serial buffer also enables transfers from the second port to the first port in a similar manner.

### RELATED APPLICATIONS

The present application is related to, and incorporates by reference, the following commonly owned, co-filed U.S. patent applications: Ser. No. 12/043,918 filed by Chi-Lie Wang and Jason Z. Mo on Mar. 6, 2008, entitled “Method To Support Flexible Data Transport On Serial Protocols”; Ser. No. 12/043,929 also filed by Chi-Lie Wang and Jason Z. Mo on Mar. 6, 2008, entitled “Protocol Translation In A Serial Buffer”; Ser. No. 12/______ (Docket No. IDT-2273) filed by Chi-Lie Wang on Mar. 6, 2008, entitled “Power Management On sRIO Endpoint”; Ser. No. 12/______ (Docket No. IDT-2274) filed by Chi-Lie Wang and Jason Z. Mo on Mar. 6, 2008, entitled “Serial Buffer To Support Rapid I/O Logic Layer Out Of Order Response With Data Retransmission”; and Ser. No. 12/______ (IDT-2277) filed by Chi-Lie Wang, Jason Z. Mo, Calvin Nguyen and Bertan Tezcan on Mar. 6, 2008, entitled “Method To Support Lossless Real Time Data Sampling And Processing On Rapid I/O End-Point”.

### FIELD OF THE INVENTION

The present invention relates to a multi-port serial buffer designed to provide reliable connections between a first system that implements a first serial protocol and a second system that implements a second serial protocol.

### RELATED ART

It is desirable for a serial buffer to be able to efficiently and flexibly store and retrieve packet data. One method for improving the flexibility of a serial buffer is to provide more than one port for the serial buffer. It would be desirable to have a method and system for improving the flexibility and efficiency of memory accesses in a serial buffer having multiple ports. More specifically, it would be desirable to have a serial buffer that enables reliable communication between a first system that implements a serial rapid IO (sRIO) protocol and a second system that implements a Lite-weight (Lite) protocol.

### SUMMARY

Accordingly, the present invention provides a multi-port serial buffer having a first port configured to implement an sRIO protocol (to enable connection to an sRIO endpoint), and a second port to be configured to implement a Lite-weight protocol (to enable connection to a field programmable device, such as an FPGA). The serial buffer implements protocol translation to enable a Lite-weight protocol packet received on the second port to be transferred as a sRIO protocol packet on the first port (and vice versa). Each protocol interface has a corresponding acknowledge/no acknowledge (ACK/NACK) mechanism for data retransmission to support reliable connection on the corresponding physical layer interface.

To transfer a Lite-weight protocol packet (hereinafter, a “Lite packet”) from the second port to the first port, protocol translation is used to convert the Lite packet to an sRIO packet format. One example of such protocol translation is described in common owned, co-filed U.S. patent application Serial No. ______/______ [Attorney Docket No. IDT-2268], by Chi-Lie Wang and Jason Mo, entitled “PROTOCOL TRANSLATION IN A SERIAL BUFFER”, which is hereby incorporated by reference.

Each incoming Lite packet has a packet identifier (ID) value, which provided to a Lite-to-sRIO ID mapping table. In response to a received Lite packet ID value, the Lite-to-sRIO ID mapping table provides a corresponding sRIO transaction identifier (ID) value. This corresponding sRIO transaction ID value is inserted into the header of the incoming Lite packet. This modified Lite packet is written to a selected queue of the serial buffer.

An sRIO request generator subsequently causes the modified Lite packet to be read from the selected queue. At this time, the header of the modified Lite packet is translated into an sRIO format, thereby creating an sRIO request packet. This sRIO request packet includes the previously inserted sRIO transaction ID value. The sRIO request packet is transferred to the first (sRIO) port, and the sRIO request generator starts a sRIO transaction timer. The sRIO request packet is eventually received by a destination sRIO device, which is coupled to the first (sRIO) port. After processing the sRIO request packet, the destination sRIO device generates an sRIO response packet, which includes the previously inserted sRIO transaction ID value. This sRIO response packet is returned to the first (sRIO) port of the serial buffer.

Within the serial buffer, sRIO response control logic processes the received sRIO response packet by providing the associated sRIO transaction ID value to the Lite-to-sRIO ID mapping table. In response, the Lite-to-sRIO ID mapping table returns the original Lite packet ID value to the sRIO response control logic. In response, the sRIO response control logic generates a Lite response packet having an XACK format, which includes the original Lite packet ID value, and transmits this Lite response packet to the second (Lite) port.

The Lite-weight protocol device that originated the Lite packet subsequently receives the Lite response packet from the second (Lite) port. End-to-end acknowledgement is achieved when this Lite-weight protocol device determines that the received Lite response packet (having the XACK format) includes the original Lite packet ID value.

If the sRIO response packet is not received by the sRIO response control logic within a predetermined time period (e.g., due to an error encountered in transit), the sRIO transaction timer will expire. In response, the sRIO response control logic generates a Lite error response packet having an XNACK format, which includes the original Lite packet ID value. This Lite error response packet is transmitted to the second (Lite) port, such that the Lite-weight protocol device that originated the Lite packet receives this Lite error response packet. Upon receiving the Lite error response packet, which includes the original Lite packet ID value, this Lite-weight protocol device is able to identify the Lite packet that encountered the error. In response, the Lite-weight protocol device may retransmit the original Lite packet to guarantee packet delivery. In an alternate embodiment, packet retransmission can be invoked on a higher protocol layer if the sRIO response packet is not received within the predetermined time period.

A similar method is used to confirm that an incoming sRIO packet received on the first (sRIO) port has been translated into a Lite request packet, and successfully processed by a Lite-weight protocol device coupled to the second (Lite) port.

In this manner, the present invention supports end-to-end acknowledgement between the first port sRIO protocol and the second port Lite protocol. Reliable connections can be maintained across different ports running different protocols, as packets encountering errors or being lost in transit can be detected and retransmitted.

The present invention will be more fully understood in view of the following description and drawings.

### BRIEF DESCRIPTION OF THE DRAWINGS

FIG. 1 is a block diagram of a serial buffer in accordance with one embodiment of the present invention.

FIG. 2 is a flow diagram illustrating the operation of Lite write control logic present in the serial buffer of FIG. 1 in accordance with one embodiment of the present invention.

FIG. 3 is a block diagram of a Lite-to-sRIO ID mapping table present in the serial buffer of FIG. 1 in accordance with one embodiment of the present invention.

FIG. 4 is a flow diagram illustrating the operation of an sRIO request generator present in the serial buffer of FIG. 1 in accordance with one embodiment of the present invention.

FIG. 5 is a flow diagram illustrating the operation of sRIO response control logic present in the serial buffer of FIG. 1 in accordance with one embodiment of the present invention.

FIG. 6 is a flow diagram illustrating the operation of sRIO write control logic present in the serial buffer of FIG. 1 in accordance with one embodiment of the present invention.

FIG. 7 is a block diagram of an sRIO-to-Lite ID mapping table present in the serial buffer of FIG. 1 in accordance with one embodiment of the present invention.

FIG. 8 is a flow diagram illustrating the operation of a Lite request generator present in the serial buffer of FIG. 1 in accordance with one embodiment of the present invention.

FIG. 9 is a flow diagram illustrating the operation of Lite response control logic present in the serial buffer of FIG. 1 in accordance with one embodiment of the present invention.

### DETAILED DESCRIPTION

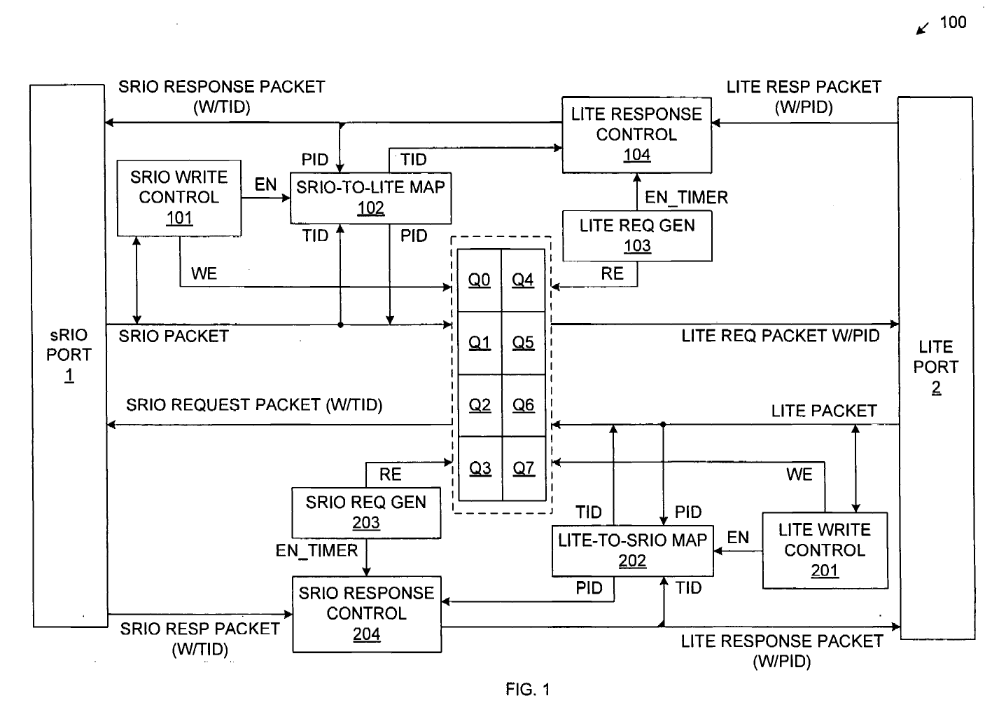

FIG. 1 is a block diagram of a serial buffer 100 in accordance with one embodiment of the present invention. Serial buffer 100 includes a first (sRIO protocol) port 1, a second (Lite-weight protocol) port 2, memory queues Q0-Q7, sRIO write control logic 101, sRIO-to-Lite ID mapping table 102, Lite request generator 103, Lite response control logic 104, Lite write control logic 201, Lite-to-sRIO ID mapping table 202, sRIO request generator 203 and sRIO response control logic 204.

In the described embodiments, the first port 1 of serial buffer 100 is configured to operate in accordance with an sRIO protocol, and provides an interface to an sRIO endpoint (not shown). The second port 2 of serial buffer 100 is configured to operate in accordance with a Lite-weight protocol, and provides an interface to a Lite-weight protocol device, such as a field programmable device (not shown). Thus, the first port 1 sends/receives sRIO packets, and the second port 2 sends/receives Lite packets.

Queues Q0-Q7 are configured to store sRIO packets received on the first port 1 and Lite packets received on the second port 2. As described in more detail below, sRIO packets received on the first port 1 are translated into Lite request packets, which are stored in queues Q4-Q7. These Lite request packets are subsequently read out of queues Q4-Q7 and provided to a destination Lite-weight protocol device through the second port 2. The Lite-weight protocol device processes the Lite request packet, and in response, returns a Lite response packet to the second port 2. The Lite response packet is used to generate an sRIO response packet, which is returned to the originating sRIO device through the first port 1.

Similarly, Lite packets received on the second port 2 are stored in queues Q0-Q3. These Lite packets are subsequently read out of queues Q0-Q3 and translated into sRIO request packets, which are provided to a destination sRIO device through the first port 1. The sRIO device processes the sRIO request packet, and in response, returns an sRIO response packet to the first port 1. The sRIO response packet is used to generate a Lite response packet, which is returned to the originating Lite-weight protocol device through the second port 2.

SRIO-to-Lite ID mapping table 102 is used to identify the correspondence between sRIO packets received from the first port 1 and corresponding Lite request packets transmitted to the second port 2, as well as the correspondence between Lite response packets received from the second port 2 and corresponding sRIO response packets returned to the first port 1. More specifically, sRIO-to-Lite ID mapping table 102 identifies a sRIO transaction identification (ID) value associated with an sRIO packet received from the first port 1, and assigns a Lite packet identification (ID) value to the corresponding Lite request packet. The Lite request packet (and the associated Lite packet ID value) is transmitted to a destination Lite-weight protocol device through the second port 2. After processing the Lite request packet, the Lite-weight protocol device returns an associated Lite response packet, which also includes the assigned Lite packet ID value. The Lite packet ID value of the returned Lite response packet is provided to sRIO-to-Lite ID mapping table 102. In response, sRIO-to-Lite ID mapping table 102 retrieves the corresponding original sRIO transaction ID value, which is included in the generated sRIO response packet.

Lite-to-sRIO ID mapping table 202 operates in a similar manner to identify the correspondence between Lite packets received from the second port 2 and corresponding sRIO request packets transmitted to the first port 1, as well as the correspondence between sRIO response packets received from the first port 1 and corresponding Lite response packets returned to the second port 2.

Serial buffer 100 enables the confirmation of data transfers between the first port 1 to the second port 2. Data transfer from the second (Lite) port 2 to the first (sRIO) port 1 will now be described. Lite write control logic 201 monitors the second port 2 to determine when a Lite packet has been received (from a Lite-weight protocol device).

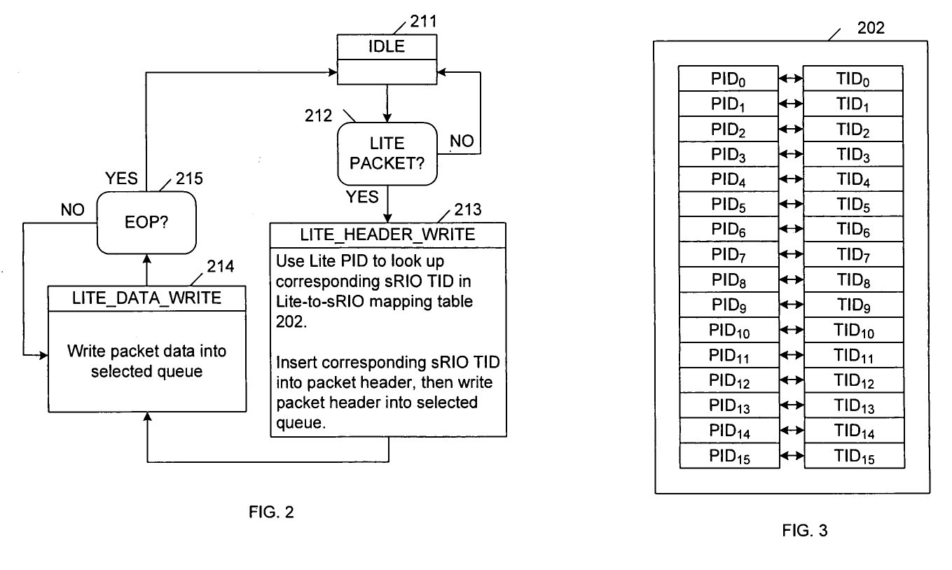

FIG. 2 is a flow diagram illustrating the operation of Lite write control logic 201 in accordance with one embodiment of the present invention. Lite write control logic 201 is initially in an IDLE state 211. If Lite write control logic 201 does not detect a received Lite packet from the second port 2 (Step 212, NO branch), Lite write control logic 201 will remain the IDLE state 211. Upon determining that a Lite packet has been received from the second port 2 (Step 212, YES branch), Lite write control logic 201 enters a LITE_HEADER_WRITE state 213. In this state 213, Lite write control logic 201 extracts the Lite packet ID value from the packet header of the received Lite packet, and provides this Lite packet ID value to Lite-to-sRIO ID mapping table 202. In the described example, the Lite packet ID value of this data transfer is represented by the value, PID₀. Lite write control logic 201 also enables a look-up function within Lite-to-sRIO ID mapping table 202. In response, Lite-to-sRIO ID mapping table 202 assigns a sRIO transaction ID value TID₀, which is linked with the provided Lite packet ID value PID₀.

FIG. 3 is a block diagram of Lite-to-sRIO ID mapping table 202 in accordance with one embodiment of the present invention. As shown in FIG. 3, the Lite packet ID values PIDₓ have corresponding sRIO transaction ID values TIDₓ, wherein x has possible values of 0 to 15. In other embodiments, Lite-to-sRIO ID mapping table 202 can have other numbers of entries. In general, the number of entries in Lite-to-sRIO ID mapping table 202 defines the number of Lite packets that serial buffer 100 can track at any given time.

Lite write control logic 201 inserts the retrieved sRIO transaction ID value TID₀ into the header of the incoming Lite packet, thereby creating a TID-modified Lite packet header. In one embodiment, the sRIO transaction ID value TID₀ replaces the Lite packet ID value PID₀ in the Lite packet header to create the TID-modified Lite packet header. Lite write control logic 201 causes the TID-modified Lite packet header to be written to a selected one of queues Q0-Q3 in LITE_HEADER_WRITE state 213.

Lite write control logic 201 then exits the LITE_HEADER_WRITE state 213, and enters a LITE_DATA_WRITE state 214, wherein the Lite packet data (of the received Lite packet) is written to the selected queue. Lite packet data is written to the selected queue as long as the Lite packet data does not include an end-of-packet (EOP) identifier (Step 215, NO branch). Upon detecting an end-of-packet (EOP) indicator in the Lite packet data (Step 215, YES branch), Lite write control logic 201 exits the LITE_DATA_WRITE state 214, and returns to the IDLE state 211.

At this time, the received Lite packet, which has been modified to include the corresponding sRIO transaction ID value TID₀, is stored in the selected queue. As described below, this TID-modified Lite packet is subsequently read out of the selected queue, and is used to generate a corresponding sRIO request packet.

SRIO request generator 203 subsequently causes the TID-modified Lite packet to be read out of the selected queue. In accordance with one embodiment, Lite-to-sRIO translation logic (not shown) is used to translate the TID-modified Lite packet header into a format that is consistent with the sRIO protocol. Note that this translation does not modify the sRIO transaction ID value TID₀, which was previously inserted into the TID-modified Lite packet header. One example of Lite-to-sRIO translation logic that can be used to perform this translation is described in common owned, co-filed U.S. patent application Ser. No. ______/______ [Attorney Docket No. IDT-2268], by Chi-Lie Wang and Jason Mo, entitled “PROTOCOL TRANSLATION IN A SERIAL BUFFER”, which is hereby incorporated by reference.

The result of the Lite-to-sRIO translation is a sRIO request packet, which includes: (1) a translated packet header that is consistent with the sRIO protocol and includes the inserted sRIO transaction ID value, TID₀, and (2) the packet data of the original Lite packet.

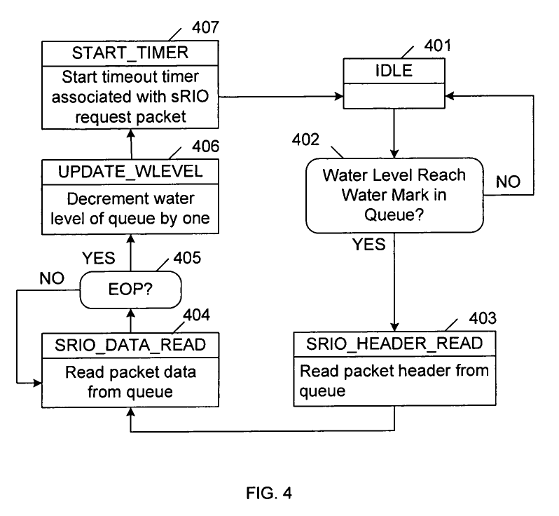

FIG. 4 is a flow diagram illustrating the operation of sRIO request generator 203 in accordance with one embodiment of the present invention. SRIO request generator 203 is initially in an IDLE state 401. SRIO request generator 203 remains in this IDLE state 401 as long as none of the queues Q0-Q3 has a water level that reaches a corresponding water mark (Step 402, NO branch). Note that the water level of a queue increases each time that a packet is written to the queue. Upon determining that the water level of a queue has reached the water mark associated with the queue (Step 402, YES branch), sRIO request generator 203 enters the SRIO_HEADER_READ state 403. Note that if the water level of more than one queue reaches its associated water mark, the queue having the higher priority is processed first.

In SRIO_HEADER_READ state 403, the oldest unprocessed TID-modified Lite packet header is read out of the selected queue and translated to a format consistent with the sRIO protocol in the manner described above. This translated header, which includes the previously inserted sRIO transaction ID value TID₀, is transferred to the first (sRIO) port 1. SRIO request generator 203 then enters the SRIO_DATA_READ state 404, wherein the packet data of the original Lite packet is read out of the selected queue. This packet data is read from the selected queue as long as this packet data does not include an end-of-packet (EOP) identifier (Step 405, NO branch). Upon detecting an end-of-packet (EOP) indicator in the packet data (Step 405, YES branch), sRIO request generator 203 exits the SRIO_DATA_READ state 404, and enters the UPDATE_WLEVEL state 406, wherein the water level of the selected queue is decremented by one. Processing then proceeds to START_TIMER state 407, wherein sRIO request generator 203 enables a timeout timer in sRIO response control logic 204. This timeout timer is associated with the sRIO request packet transmitted during states 403 and 404. More specifically, this timeout timer is linked to the sRIO transaction ID value (TID₀) of the transmitted sRIO request packet. sRIO request generator 203 then returns to the IDLE state 401.

The sRIO request packet read from the selected queue is routed from the first port 1 to a corresponding destination sRIO device (e.g., sRIO endpoint). Upon receiving and processing the sRIO request packet, the destination sRIO device generates a sRIO response packet, which is returned to sRIO response control logic 204 (via the first port 1). This sRIO response packet has a packet header that includes the same sRIO transaction ID value (TID₀) present in the corresponding sRIO request packet.

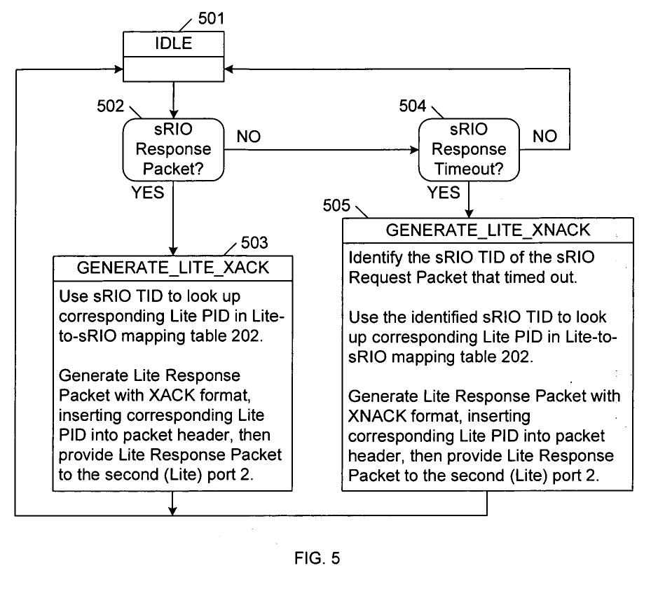

FIG. 5 is a flow diagram illustrating the operation of sRIO response control logic 204 in accordance with one embodiment of the present invention. SRIO response control logic 204 is initially in an IDLE state 501. SRIO response control logic 204 determines whether an sRIO response packet has been received from the first port 1 (Step 502). Upon detecting that an sRIO response packet has been received from the first port 1 (Step 502, YES branch), sRIO response control logic 204 enters a GENERATE_LITE_XACK state 503. In this state 503, sRIO response control logic 204 extracts the sRIO transaction ID value (e.g., TID₀) from the packet header of the received sRIO response packet, and provides this sRIO transaction ID value TID₀ to Lite-to-sRIO ID mapping table 202. SRIO response control logic 204 also enables a look-up function within Lite-to-sRIO ID mapping table 202. As described above, the sRIO transaction ID value TID₀ is associated (linked) with the original Lite packet ID value PID₀ within Lite-to-sRIO ID mapping table 202. As a result, Lite-to-sRIO ID mapping table 202 provides the original Lite packet ID value PID₀ in response to the provided sRIO transaction ID value TID₀.

SRIO response control logic 204 then generates a Lite response packet having an XACK (acknowledge) format, wherein the Lite packet ID value PID₀ retrieved from Lite-to-sRIO mapping table 202 is included in the Lite response packet header. SRIO response control logic 204 then transmits this Lite response packet to the second port 2. This Lite response packet is routed from the second port 2 to the Lite-weight protocol device that provided the original Lite packet to the second port 2. Upon receiving the Lite response packet, this Lite-weight protocol device determines that the Lite packet associated with the Lite packet ID value PID₀ was successfully processed. In this manner, the Lite-weight protocol device that initially transmitted the original Lite packet receives confirmation that the associated data was received and processed by the destination sRIO device. Processing then returns to the IDLE state 501.

Returning now to Step 502, if sRIO response control logic 204 has not received an sRIO response packet from the first port 1 (Step 502, NO branch), then sRIO response control logic 204 determines whether any of the timeout timers associated with previously transmitted sRIO request packets have expired (Step 504). If none of these timeout timers have expired (Step 504, NO branch), then processing returns to the IDLE state 501. However, if a timeout timer has expired (Step 504, YES branch), then processing proceeds to GENERATE_LITE_XNACK state 505.

Within the GENERATE_LITE_XNACK state 505, sRIO response control logic 204 identifies the sRIO transaction ID value (e.g., TID₀) associated with the expired timeout timer. As described above, this sRIO transaction ID value identifies a corresponding sRIO request packet. Thus, identifying the sRIO transaction ID value associated with the expired timeout timer effectively identifies a previously transmitted sRIO request packet. In this manner, the sRIO response control logic 204 effectively identifies an sRIO request packet that did not receive a response within the time period specified by the timeout timer, thereby indicating that this sRIO request packet was lost or was subject to an error.

SRIO response control logic 204 transmits the sRIO transaction ID value (e.g., TID₀) associated with the expired timeout timer to Lite-to-sRIO ID mapping table 202. SRIO response control logic 204 also enables a look-up function within Lite-to-sRIO ID mapping table 202. As described above, the sRIO transaction ID value TID₀ is associated (linked) with the original Lite packet ID value PID₀ within Lite-to-sRIO ID mapping table 202. As a result, Lite-to-sRIO ID mapping table 202 provides the original Lite packet ID value PID₀ in response to the provided sRIO transaction ID value TID₀.

SRIO response control logic 204 then generates a Lite response packet having an XNACK (no acknowledgement) format, wherein the Lite packet ID value PID₀ retrieved from Lite-to-sRIO ID mapping table 202 is included in the Lite response packet header. SRIO response control logic 204 then transmits this Lite XNACK response packet to the second port 2. This Lite XNACK response packet is routed from the second port 2 to the Lite-weight protocol device that provided the original Lite packet to the second port 2. In this manner, the Lite-weight protocol device that initially transmitted the original Lite packet is informed that the associated data was not properly received by the intended sRIO endpoint. Thus informed, the Lite-weight protocol device may re-send the original Lite packet to guarantee delivery and ensure a reliable connection from the second port 2 to the first port 1. Processing proceeds from GENERATE_LITE_XNACK state 505 to the IDLE state 501.

Data transfer from the first (sRIO) port 1 to the second (Lite) port 2 is substantially similar to data transfer from the second port 2 to the first port 1 (described above). Data transfer from the first (sRIO) port 1 to the second (Lite) port 2 will now be described.

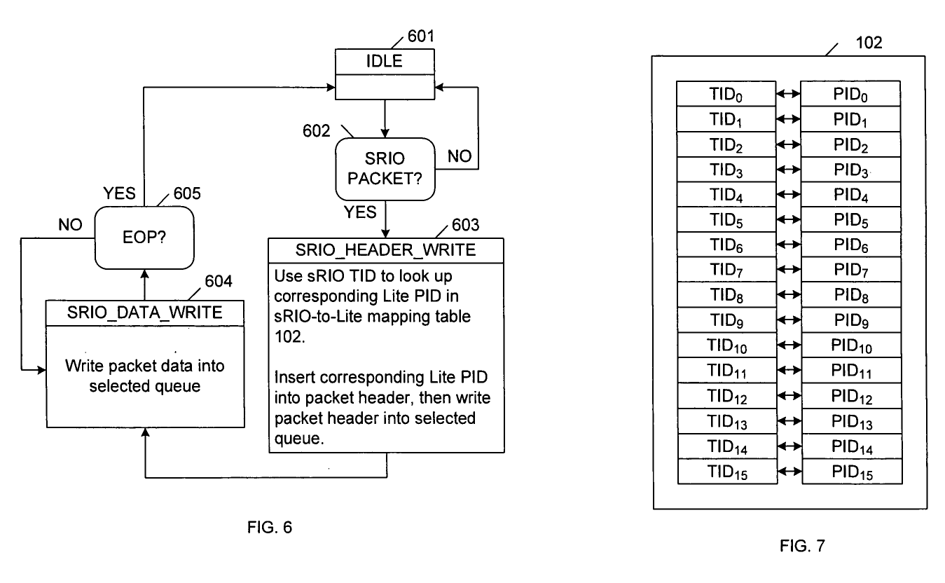

SRIO write control logic 101 monitors the first port 1 to determine when an sRIO packet has been received (from an sRIO endpoint). FIG. 6 is a flow diagram illustrating the operation of sRIO write control logic 101 in accordance with one embodiment of the present invention. SRIO write control logic 101 is initially in an IDLE state 601. If sRIO write control logic 101 does not detect a received sRIO packet from the first port 1 (Step 602, NO branch), sRIO write control logic 101 will remain the IDLE state 601. Upon determining that an sRIO packet has been received from the first port 1 (Step 602, YES branch), sRIO write control logic 101 enters a SRIO_HEADER_WRITE state 603. In this state 603, sRIO write control logic 101 extracts the sRIO transaction ID value from the packet header of the received sRIO packet, and provides this sRIO transaction ID value to sRIO-to-Lite ID mapping table 102. In the described example, the sRIO transaction ID value of this data transfer is represented by the value, TID₁. sRIO write control logic 101 also enables a look-up function within sRIO-to-Lite ID mapping table 102. In response, sRIO-to-Lite ID mapping table 102 provides a Lite packet ID value PID₁, which is associated (i.e., linked) with the provided sRIO transaction ID value TID₁.

FIG. 7 is a block diagram of sRIO-to-Lite ID mapping table 102 in accordance with one embodiment of the present invention. As shown in FIG. 7, the sRIO transaction ID values TIDₓ have corresponding Lite packet ID values PIDₓ, wherein x has possible values of 0 to 15. In other embodiments, sRIO-to-Lite ID mapping table 102 can have other numbers of entries. In general, the number of entries in sRIO-to-Lite ID mapping table 102 is selected to correspond to the number of sRIO packets that can be tracked by serial buffer 100. Note that the PID/TID values stored in sRIO-to-Lite ID mapping table 102 are independent of the PID/TID values stored in Lite-to-sRIO ID mapping table 202.

Also within SRIO_HEADER_WRITE state 603, sRIO-to-Lite translation logic (not shown) is used to translate the sRIO packet header into a format that is consistent with the Lite-weight protocol. One example of sRIO-to-Lite translation logic that can be used to perform this translation is described in common owned, co-filed U.S. patent application Ser. No. ______/______ [Attorney Docket No. IDT-2268], by Chi-Lie Wang and Jason Mo, entitled “PROTOCOL TRANSLATION IN A SERIAL BUFFER”, which is hereby incorporated by reference.

SRIO write control logic 101 combines the retrieved Lite packet ID value PID₁ with the results of the sRIO-to-Lite header translation to create a translated Lite packet header, which is consistent with the Lite-weight protocol. In one embodiment, the Lite packet ID value PID₁ replaces the sRIO transaction ID value TID₁ of the original sRIO packet header. The translated Lite packet header is written to a selected one of queues Q4-Q7 in SRIO_HEADER_WRITE state 603.

SRIO write control logic 101 then exits the SRIO_HEADER_WRITE state 603, and enters a SRIO_DATA_WRITE state 604, wherein the sRIO packet data (of the received sRIO packet) is written to the selected queue. sRIO packet data is written to the selected queue as long as the sRIO packet data does not include an end-of-packet (EOP) identifier (Step 605, NO branch). Upon detecting an end-of-packet (EOP) indicator in the sRIO packet data (Step 605, YES branch), sRIO write control logic 101 exits the SRIO_DATA_WRITE state 604, and returns to the IDLE state 601.

At this time, the selected queue stores the translated Lite packet header (which includes the inserted Lite packet ID value PID₁) and the packet data of the original sRIO packet. Together, the translated Lite packet header and sRIO packet data form a Lite request packet, which is subsequently read from the selected queue.

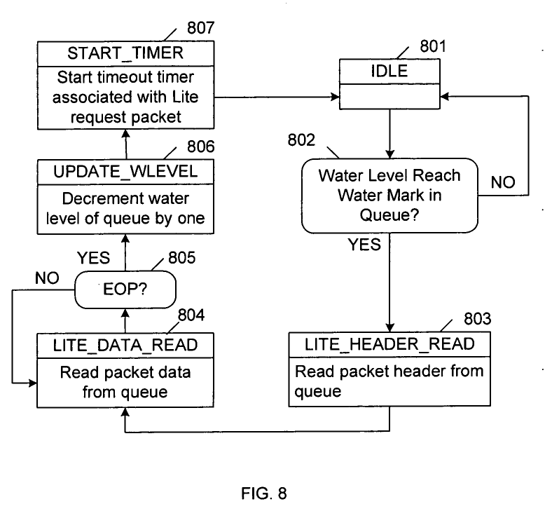

Lite request generator 103 causes the Lite request packets stored in queues Q4-Q7 to be read out to the second (Lite) port 2. FIG. 8 is a flow diagram illustrating the operation of Lite request generator 103 in accordance with one embodiment of the present invention. Lite request generator 103 is initially in an IDLE state 801. Lite request generator 103 remains in this IDLE state 801 as long as none of the queues Q4-Q7 has a water level that reaches a corresponding water mark (Step 802, NO branch). Note that the water level of a queue increases each time that a Lite request packet is written to the queue. Upon determining that the water level of a queue has reached the water mark associated with the queue (Step 802, YES branch), Lite request generator 103 enters the LITE_HEADER_READ state 803. Note that if the water level of more than one queue reaches its associated water mark, the queue having the higher priority is processed first.

In LITE_HEADER_READ state 803, the packet header of the oldest unprocessed Lite request packet is read out of the selected queue and transferred to the second port 2. Note that the Lite packet ID previously inserted by sRIO write control logic 101 (e.g., PID₁) is included in this packet header. Lite request generator 103 then enters the LITE_DATA_READ state 804, wherein the packet data of the Lite request packet is read out of the selected queue. This Lite request packet data is read from the selected queue as long as this packet data does not include an end-of-packet (EOP) identifier (Step 805, NO branch). Upon detecting an end-of-packet (EOP) indicator in the Lite request packet data (Step 805, YES branch), Lite request generator 103 exits the LITE_DATA_READ state 804, and enters the UPDATE_WLEVEL state 806, wherein the water level of the selected queue is decremented by one. Processing then proceeds to START_TIMER state 807, wherein Lite request generator 103 enables a timeout timer in Lite response control logic 104. This timeout timer is associated with the Lite request packet transmitted during states 803 and 804. More specifically, this timeout timer is linked to the Lite packet ID value (PID₁) of the transmitted Lite request packet. Lite request generator 103 then returns to the IDLE state 801.

The Lite request packet read from the selected queue is routed from the second port 2 to a destination Lite-weight protocol device. Upon receiving and processing the Lite request packet, the destination Lite-weight protocol device generates a Lite response packet, which is returned to Lite response control logic 104 (via the second port 2). This Lite response packet has a packet header that includes the same Lite packet ID value (PID₁) present in the received Lite request packet.

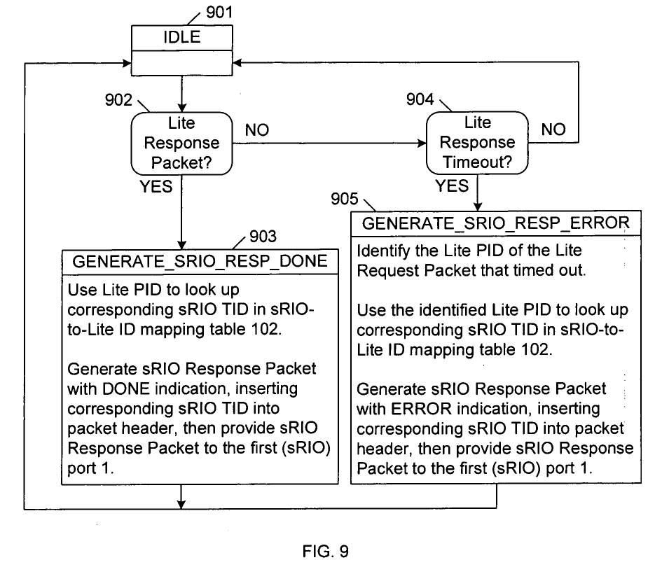

FIG. 9 is a flow diagram illustrating the operation of Lite response control logic 104 in accordance with one embodiment of the present invention. Lite response control logic 104 is initially in an IDLE state 901. Lite response control logic 104 determines whether a Lite response packet has been received from the second (Lite) port 2 (Step 902). Upon detecting that a Lite response packet has been received from the second port 2 (Step 902, YES branch), Lite response control logic 104 enters a GENERATE_SRIO_RESP_DONE state 903. In this state 903, Lite response control logic 104 extracts the Lite packet ID value (e.g., PID₁) from the packet header of the received Lite response packet, and provides this Lite packet ID value PID₁ to sRIO-to-Lite ID mapping table 102. Lite response control logic 104 also enables a look-up function within sRIO-to-Lite ID mapping table 102. As described above, the Lite packet ID value PID₁ is associated (linked) with the original sRIO transaction ID value TID₁ within sRIO-to-Lite ID mapping table 102. As a result, sRIO-to-Lite ID mapping table 102 provides the original sRIO transaction ID value TID₁ in response to the provided Lite packet ID value PID₁.

Lite response control logic 104 then generates an sRIO response packet having a DONE indication, wherein the sRIO transaction ID value TID₁ retrieved from sRIO-to-Lite ID mapping table 102 is included in the sRIO response packet header. Lite response control logic 104 then transmits this sRIO response packet to the first (sRIO) port 1. This sRIO response packet is routed from the first port 1 to the sRIO device that provided the original sRIO packet to the first port 1. In this manner, the sRIO device that initially transmitted the original sRIO packet receives confirmation that the associated data was properly received and processed by the destination Lite-weight protocol device. Processing then returns to the IDLE state 901.

Returning now to Step 902, if Lite response control logic 104 has not received a Lite response packet from the second port 2 (Step 902, NO branch), then Lite response control logic 104 determines whether any of the timeout timers associated with previously transmitted Lite request packets have expired (Step 904). If none of these timeout timers have expired (Step 904, NO branch), then processing returns to the IDLE state 901. However, if a timeout timer has expired (Step 904, YES branch), then processing proceeds to GENERATE_SRIO_RESP_ERROR state 905.

Within the GENERATE_SRIO_RESP_ERROR state 905, Lite response control logic 104 identifies the Lite packet ID value (e.g., PID₁) associated with the expired timeout timer. As described above, this Lite packet ID value identifies a corresponding Lite request packet. Thus, identifying the Lite packet ID value associated with the expired timeout timer effectively identifies a previously transmitted Lite request packet. In this manner, the Lite response control logic 104 effectively identifies a Lite request packet that did not receive a response within the time period specified by the timeout timer, thereby indicating that this Lite request packet was lost or was subject to an error.

Lite response control logic 104 transmits the Lite packet ID value (e.g., PID₁) associated with the expired timeout timer to sRIO-to-Lite ID mapping table 102. Lite response control logic 104 also enables a look-up function within sRIO-to-Lite ID mapping table 102. As described above, the Lite packet ID value PID₁ is associated (linked) with the original sRIO transaction ID value TID₁ within sRIO-to-Lite ID mapping table 102. As a result, sRIO-to-Lite ID mapping table 102 provides the original sRIO transaction ID value TID₁ in response to the provided Lite packet ID value PID₁.

Lite response control logic 104 then generates an sRIO response packet having an ERROR indication, wherein the sRIO transaction ID value TID₁ retrieved from sRIO-to-Lite ID mapping table 102 is included in the sRIO response packet header. Lite response control logic 104 then transmits this sRIO response packet (with ERROR indication) to the first port 1. This sRIO response packet is routed from the first port 1 to the sRIO device that provided the original sRIO packet to the first port 1. In this manner, the sRIO device that initially transmitted the original sRIO packet is informed that the associated data was not properly received and processed by the destination Lite-weight protocol device. Thus informed, the sRIO device may re-send the original sRIO packet to guarantee delivery and ensure a reliable connection from the first port 1 to the second port 2. Processing proceeds from GENERATE_SRIO_RESP_ERROR state 905 to the IDLE state 901.

Although the present invention has been described in connection with various embodiments, it is understood that variations of these embodiments would be obvious to one of ordinary skill in the art. Thus, the present invention is limited only by the following claims.

We claim:

1. A method of operating a serial buffer having a first port that implements a first protocol and a second port that implements a second protocol, different than the first protocol, the method comprising:
receiving a first request packet consistent with the first protocol on the first port, the first request packet having a first identification value;
associating the first identification value with a corresponding second identification value that is compatible with the second protocol;
modifying the first request packet to include the second identification value;
transmitting the modified first request packet to the second port;
receiving a first response packet including the second identification value on the second port, wherein the first response packet is provided in response to the modified first request packet;
associating the second identification value of the first response packet with the first identification value;
modifying the first response packet to include the first identification value; and
transmitting the modified first response packet to the first port.

2. The method of claim 1, wherein the first protocol is a serial rapid I/O (sRIO) protocol, and the second protocol is a Lite-weight protocol.

3. The method of claim 2, wherein the first identification value is an sRIO transaction identification value, and the second identification value is a Lite-weight packet identification value.

4. The method of claim 1, wherein the first protocol is a Lite-weight protocol and the second protocol is a serial rapid I/O (sRIO) protocol.

5. The method of claim 4, wherein the first identification value is a Lite-weight packet identification value, and the second identification value is an sRIO transaction identification value.

6. The method of claim 1, further comprising:
starting a first timer having a first timeout period upon transmitting the modified first request packet to the second port; and
associating the first timer with the second identification value.

7. The method of claim 6, further comprising transmitting a first control packet to the first port if the first timer reaches the first timeout period before the first response packet is received on the second port, wherein the first control packet identifies a problem associated with the first request packet.

8. The method of claim 7, wherein the first control packet includes the first identification value.

9. The method of claim 1, further comprising storing the modified first request packet in a queue prior to transmitting the modified first request packet to the second port.

10. The method of claim 9, further comprising operating the queue in a first in, first out (FIFO) manner.

11. The method of claim 1, further comprising:
receiving a second request packet consistent with the second protocol on the second port, the second request packet having a third identification value;
associating the third identification value with a corresponding fourth identification value that is compatible with the first protocol;
modifying the second request packet to include the fourth identification value;
transmitting the modified second request packet to the first port;
receiving a second response packet including the fourth identification value on the first port, wherein the second response packet is provided in response to the modified second request packet;
associating the fourth identification value of the second response packet with the third identification value;
modifying the second response packet to include the third identification value; and
transmitting the modified second response packet to the second port.

12. A serial buffer comprising:
a first port that implements a first protocol;
a second port that implements a second protocol, different than the first protocol;
a first write controller configured to receive a first packet consistent with the first protocol from the first port, wherein the first packet includes a first identification value;
first mapping logic configured to associate the first identification value with a second identification value that is compatible with the second protocol;
a first queue configured to store a first request packet which is consistent with the second protocol, and includes the first packet modified to include the second identification value; and
a first read controller configured to read the first request packet from the first queue, and transmit the first request packet to the second port.

13. The serial buffer of claim 12, further comprising:
a first response controller configured to receive a first response packet consistent with the second protocol from the second port, wherein the first response packet represents a response to the first request packet and includes the second identification value, wherein the first response controller is further configured to: (1) use the first mapping logic to associate the second identification value of the first response packet with the first identification value, (2) modify the first response packet to include the first identification value, thereby creating a modified first response packet, and then (3) transmit the modified first response packet to the first port.

14. The method of claim 13, wherein the first protocol is a serial rapid I/O (sRIO) protocol, and the second protocol is a Lite-weight protocol.

15. The method of claim 13, wherein the first protocol is a Lite-weight protocol and the second protocol is a serial rapid I/O (sRIO) protocol.

16. A serial buffer comprising:
a first port that implements a first protocol;
a second port that implements a second protocol, different than the first protocol;
first mapping logic configured to associate a first identification value of a first packet received on the first port with a second identification value that is compatible with the second protocol;
means for combining the first packet with the second identification value to create a first request packet; and
means for transmitting the first request packet to the second port.

17. The serial buffer of claim 16, further comprising:
means for identifying the second identification value in a first response packet received on the second port in response to the first request packet,
means for replacing the second identification value in the first response packet with the first identification value, thereby creating a modified first response packet that is transmitted to the first port.

18. The method of claim 17, wherein the first protocol is a serial rapid I/O (sRIO) protocol, and the second protocol is a Lite-weight protocol.

19. The method of claim 17, wherein the first protocol is a Lite-weight protocol and the second protocol is a serial rapid I/O (sRIO) protocol.
